(19) United States
(12) Patent Application Publication
(10) Pub. No.: US 2009/0141920 A1
(43) Pub. Date: Jun. 4, 2009

(54) Ear Mold

(75) Inventor: Keita Suyama, Chiba-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Suyama Dental Laboratory Inc., Chiba-shi (JP)

(21) Appl. No.: 11/883,504

(22) PCT Filed: Jan. 24, 2006
(86) PCT No.: PCT/JP2006/301060

§ 371 Date: May 27, 2008

(30) Foreign Application Priority Data
Feb. 1, 2005 (JP) 2005-025517

(51) Int. Cl. H04R 25/00

(52) U.S. Cl. 381/328; 264/259

(57) ABSTRACT

[Technical Problem] In regard to an ear mold for a hearing aid, there are provided the ear mold which a metal bush is settled in a tube for joint of the hearing aid, said metal bush has been used on account of settlement of said tube for joint of the hearing aid, and which a tube is adhered by an adhesive, the adhesive has been used on account of settlement of said tube. However, said ear mold has disadvantages that said tube is easily moved for the reason of instability, said tube drops out from the ear mold, and the ear mold occurred the problem of a phenomenon of a howling by sound leak-out.

[Technical Solution] The ear mold which is configured by embedding a connection and fixation member (A hub) 2 having a hole for connection to a hearing aid body and an introductory-hole of a forming material of said ear mold 2010 into the ear mold 1 on the basis of an ear impression. The connection and fixation member (the hub) 2 is embedded into the ear mold 1 when molding of the ear mold.

### FILED OF THE INVENTION

The present invention relates to the ear mold in an ear hook hearing aid, specifically to the ear mold which may be inserted into an external auditory meatus (external ear cavity), and to the ear mold of an ear hook hearing aid which may be hanged behind the section of an ear pinna.

### BACKGROUND OF THE INVENTION

A hearing aid may be used by one who is hard of hearing and so on.

The hearing aid comprising a microphone which may be received sound from external world, a speaker which the sound may be transmitted into an ear, a body portion having an electric device (include an electric battery) which may be drove the microphone and the speaker, and the ear mold which may be inserted into a ear (the external auditory meatus) and may be joined said body portion.

Whatever an efficiency of the body portion of the hearing aid may be raised, when the ear mold cannot be adapted to a user, it gives an unpleasant feeling against the user in a long-time use, and it cannot maintain a tone's proper quality. In the ear mold for the hearing aid, the problem of occurring of a sound pee-pee and sound leak-out (what is called a phenomenon of a howling) is important thing.

In regard to the ear mold for the hearing aid, lately, the ear mold of a custom-made which is produced according to the order of a shape of the ear of an each user has been recommended as above-mentioned ear mold. However, said ear mold of custom-made too causes some problems that give an incompatibility feeling against the user, easily gets out of the user's ear, and occurs the phenomenon of the howling.

The forming material of the ear mold has been used a MMA (methylmethacrylate) resin, for example, but lately a silicon resin has been used as the forming material of the ear mold. Because, the silicon resin can be reduced a burden at the time of touch with the external auditory meatus, the silicon resin has not an allergy reaction and the like, consequently, the silicon resin can be adapted for the above-mentioned use.

For manufacture of the ear mold of the custom-made, generally, a forming material of an impression such as the silicon system material inserts into the external auditory meatus of the user, after hardening, the ear impression make by means of molding (forming). After spread wax and the like in a surface of said ear impression, a plaster pours into a pattern of said ear impression, and then said ear impression takes up from said pattern. After removing of said wax and a paraffin wax from said ear impression, and then a pattern of plaster make forming based on this ear impression. The forming material of the ear mold such as the silicon resin pours into said pattern of plaster, after hardening (molding) of said forming material of the ear mold, and then the ear mold of the custom-made can be obtained.

Heretofore, as said silicon ear mold, it was proposed that said silicon ear mold shown in FIG. 8A which is prepared by the above-mentioned method and based on the ear impression picked from the user. This silicon ear mold can be made by as follows.

A tube 802 passes into a lead-sound-hole of the silicon ear mold 801, this tube 802 passes through said ear mold 801 as shown in FIG. 8A, the metal bush 803 as shown in FIG. 8B fits into an end section of this tube 802, this tube 802 pulls back for reasons of this metal bush 803 puts in an end section of this silicon ear mold 801. In this case, said metal bush 803 has been used on account of settlement of the above-mentioned tube 802.

However, said silicon ear mold has disadvantage that said tube 802 is easily moved for the reason of instability, because said tube 802 is settled by said metal bush 803.

Also, said silicon ear mold has disadvantage that the tube 802 is destroyed by stress concentrated on the above-mentioned put-spot of ear mold 801 when takes away by oneself, and the tube 802 drops out from the ear mold 801.

Further, in case of small of the external auditory meatus, the tube 802 can not maintain necessary thickness for keeping of intensity of a silicon material, because the tube 802 is put in the inside of an ear mold 801 and the tube 802 is necessary thickness the thing itself.

Furthermore, if increase the thickness of the tube 802, an ear mold has surplus thickness of the portion of the external auditory meatus against to the ear mold.

On the other hand, there are provided the silicon ear mold 701 as shown in FIG. 7 which manufactured by previously-mentioned method. In this silicon ear mold 701, a plastics-elbow or nylon-L-tube 702 insert into the lead-sound-hole of silicon ear mold 701 as shown in FIG. 7. Said plastics-elbow or nylon-L-tube 702 is connected with said silicon ear mold 701 by an adhesive. Namely, said plastics-elbow or nylon-L-tube 702 is fixed by the glued-part 703 of said plastics-elbow or nylon-L-tube 702 in the inside of said silicon ear mold 701. In said silicon ear mold 701, as shown in the drawings, the one end portion of plastics-elbow or nylon-L-tube 702 is connected by an adhesive in form of putting away the inside of said silicon ear mold 701.

As shown in the drawings, the other end portion of the tube for joint of the hearing aid (vinyl tube) 704 may be joined with said plastics-elbow or nylon-L-tube 702.

In said silicon ear mold, the plastics-elbow or nylon-L-tube 702 doesn't put away still the inside of said silicon ear mold 701. Said plastics-elbow or nylon-L-tube 702 cuts off under suitable length.

Therefore, said plastics-elbow or nylon-L-tube 702 can be corresponded flexibility still in case of small of the external auditory meatus. Said plastics-elbow or nylon-L-tube 702 is different from said silicon ear mold 801 as previously mentioned as shown in FIG. 8.

For reason of stiffen of said vinyl tube 704 became increase with use, it is necessary to change periodically, but said vinyl tube 704 is not one-body and is independent from said ear mold 701 through the intervention of said plastics-elbow or nylon-L-tube 702, therefore the working of exchange become easy.

But, said silicon ear mold has problems that intensity of adhesive become lack, said plastics-elbow or nylon-L-tube 702 detaches easily or drops out from said ear mold 701, and occurs the phenomenon of the howling by a sound pee-pee and sound leak-out.

### DISCLOSURE OF INVENTION

### Technical Problem

It is an object of the present invention to provide a technology which can be dissolved the problems issued at those prior art technologies.

The above and other objects and novel features of the present invention will become apparent from the following specification and drawings.

### Technical Solution

The present invention's Claims is as follows.

(Claim 1)The ear mold comprises: a connection and fixation member for a tube for joint of a hearing aid having a hole for connection to a hearing aid body and an introductory-hole for a forming material of the ear mold is embedded in the ear mold based on an ear-impression.

(Claim 2) An ear mold as claimed 1, wherein said connection and fixation member has a body portion having the introductory-hole for the forming material of the ear mold and a joint portion having the hole for connection to the hearing aid.

(Claim 3) An ear mold as claimed 1, wherein said connection and fixation member get stuck in the ear mold by the existence of the introductory-hole for the forming material of the ear mold.

(Claim 4) An ear mold as claimed 1, wherein said ear mold is connected with the tube for connection to the hearing aid in said hole for connection to the hearing aid of said connection and fixation member.

(Claim 5) An ear mold as claimed 1, wherein said tube for joint of the hearing aid comprises plural tubes.

(Claim 6) An ear mold as claimed 1, wherein said forming material of the ear mold is the silicon resin.

### AN EFFECT OF INVENTION

According to the present invention has following advantages.

### (1) Improvement of Stability of Use Put Into the Hearing Aid at Use of the Ear Mold

The ear hook hearing aid is named “the ear hook hearing aid” where the body portion of the ear hook hearing aid hang behind the section of an ear pinna and using hook on the ear.

In order to stability of said body portion of the ear hook hearing aid on behind the section of an ear pinna, it is necessary cooperation with the ear tip or the ear mold putted into the ear hole.

If too much soft material use as the tube for joint of the hearing aid, the stability spoils largely.

Therefore, in the present invention, the connection and fixation member embeds into the ear mold and introduce the forming material of the ear mold into the ear mold through an introductory-hole for the forming material of the ear mold in said connection and fixation member.

Therefore, according to the present invention, said connection and fixation member can be contacted with the forming material of the ear mold and said connection and fixation member can be fixed with said ear mold.

Therefore, according to the present invention, said connection and fixation member is able to immobile in said ear mold, and can be supported by stability to the tube for joint of the hearing aid.

Therefore, the present invention may be increased the improvement of stability of use put into the hearing aid when the ear mold is used.

### (2) The Prevention of Dropping Out of the Tube For Connection to a Hearing Aid (Prevention of Dropping Out of L-tube)

In usual ear mold, the fix of the tube etc lied for connection between the body portion of the ear mold and the hearing aid, specially a parts contacted with the ear mold is difficult and the tube drop out from the ear mold in a long-time use, therefore the problem of an occurrence of a howling is caused.

On the other hand, according to the present invention, the ear mold which the tube does not drop out from said ear mold and may be proof against external force caused by removal of the ear mold can be even long-time use.

Because, in the present invention, the connection and fixation member embeds into the ear mold and introduce the forming material of the ear mold into the ear mold through an introductory-hole for the forming material of the ear mold in said connection and fixation member, hence, according to the present invention, said connection and fixation member can be contacted with the forming material of the ear mold and said connection and fixation member can be fixed with said ear mold.

### (3) The Prevention of Floating of the Tube for Joint of the Hearing Aid

When the ear mold puts into the ear, it is desirable that the tube for joint of the hearing aid manufacture such as no floating from the point of the joint of the ear mold to the ear mold. Because when said floating produce at said place, the hand and finger etc become hang on said the section of the floating and become easily take off from an ear.

On the other hand, according to present invention, the direction (angle) of the tube for joint of the hearing aid can be control properly when making time of mold, hence, the present invention can be solved these problems.

And for the user of the hearing aid, it is desirable that the ear mold and the tube is inconspicuous, according to circumstances, hide said ear mold and the tube by a hair.

On the other hand, according to present invention, the direction (angle) of between the connection and fixation member and the tube for joint of the hearing aid can be change properly when making time of mold, hence, the present invention can be solved these problems.

### (4) Simplify of the Working of Exchange for Reason of Inferiority of the Tube for Joint of the Hearing Aid With the Passing Time

The tube for joint of the hearing aid is necessary to exchange for reason that said tube causes inferiority of crack and stiffen and so on.

So far, it is necessary to take away this parts, and it is difficult the working of exchange.

However, according to the present invention, said tube can be exchanged easily, because said tube join with the tube for joint of ear-mold-side through plastics-elbow or nylon L-tube and said tube independent from the ear mold.

### BEST MODE FOR CARRYING OUT THE INVENTION

The examples of the present invention will be described according to the drawings.

### EXAMPLE

As shown in FIG. 1, FIG. 2 and FIG. 3, in the present invention, the connection and fixation member 2 is embedded in the ear mold 1.

Said connection and fixation member 2 comprises the joint portion 200 and the body portion 201.

Said joint portion 200 has the joint-hole for the tube joint of ear-mold-side 2000 and said body portion 201 has the introductory-hole for the forming material of the ear mold 2010.

In the ear mold of the present invention, as shown in the drawings, the connection and fixation member (Hereinafter referred to as a hub )2 is embedded into the ear mold 1.

The ear mold of the custom-made of the present invention can be manufactured as follows.

The forming material for the lug plug section such as silicon material inserts into the external auditory meatus of the user, after hardening, after that, an ear-impression makes by means of that molding (forming). After that, said ear-impression takes up from the external auditory meatus of the user. After, the forming material of the ear mold pours into a pattern of plaster based on said ear-impression. After, the forming material of the ear mold make hardening, then the molded (shaped) ear mold can be obtained.

In the present invention, on the occasion of the molding (shaping) of the ear mold based on the above-mentioned method, said hub 2 embeds into the ear mold 1 and introduces the forming material of the ear mold 1 into the ear mold 1 through an introductory-hole for the forming material of the ear mold 2010 in said hub 2.

Therefore, according to the present invention, said hub 2 can be contacted with the forming material of the ear mold 1 and can be fixed with said ear mold 1.

Therefore, according to the present invention, said hub 2 is able to immobile in said ear mold 1, and can be supported and stabled in joint of the tube for joint of the hearing-aid. This point, it is different from the prior art that the metal bush 803 puts in an end section of the traditional tube 802 as in shown FIG. 8 and then said tube 802 move owing to unsettlement.

According to the present invention, said hub 2 can be contacted with the forming material of the ear mold 1 and can be fixed with said ear mold 1, it is different from the prior art that said silicon ear mold 701 as shown in FIG. 7 has problems regarding of lack of intensity of adhesive and occurs the phenomenon of the howling by a sound pee-pee and sound leak-out, and said plastics-elbow or nylon-L-tube 702 detaches easily or drops out from said ear mold 701.

Two or three examples of the hubs are shown in FIG. 4, FIG. 5 and FIG. 6.

The body portion of the hub 2 may be composed a rectangular cube, for example, as shown in the drawings.

As shown in the drawings, the body portion of said hub 2 has the introductory-hole for a forming material of the ear mold 2010 in both side end portion of said hub 2.

The joint portion 200 to the tube for joint of ear-mold-side of said hub 2 comprises a circular cylinder, for example, as shown in the drawings, and has the joint-hole for the tube joint of ear-mold-side 2000 in the central portion.

FIG. 5 shows the example having the part of a curve in the part of the body portion of the hub 2.

Therefore, said hub 2 may be contacted with the ear mold 1 all the more, and the fixing of between said hub 2 and the ear mold 1 may be more fixed. Further, said hub 2 may be miniaturized.

FIG. 6 shows the example increased numbers of the introductory-hole for the forming material of the ear mold 2010 in the body portion of the hub 2, for example, said total this numbers may be composed with four numbers having two this numbers in each both side of end portion of the hub 2.

Therefore, said hub 2 may be contacted with the forming material of the ear mold 1 all the more, and the fixing of between said hub 2 and the ear mold 1 may be more fixed all the more. Said hub 2 in the ear mold can stable because of reducing of revolution.

In the joint-hole for the tube joint of ear-mold-side 2000 of the joint portion 200 of said hub, said hub 2 may be joined with the tube for joint of the hearing aid 3, as shown in FIG. 1.

This tube for joint of the hearing aid 3 may be composed by the plural tubes.

Said tube for joint of the hearing aid 3 composes the tube for joint of ear-mold-side which join with the ear mold 300 and the tube for joint of ear-hook-hearing-side in need of exchanging 301.

Said joint tube of ear-mold-side 300 may be composed by the plastics-elbow or nylon-L-tube, for example. Said tube of ear-mold-side 300 may be joined with the tube for joint of ear-hook-hearing-side in need of exchanging 301.

Said joint tube of ear-hook-hearing-side 301 may be composed by the tube made a polyvinylchloride, for example.

For example, the joint of said hub 2 with said joint tube of ear-mold-side 300 may be performed by an adhesive.

Said joint tube of ear-mold-side 300 cuts off at the desirable length, and said joint tube of ear-mold-side 300 may be joined with the hub 2 fixed in the end portion of the ear mold 1.

Said joint tube of ear-mold-side 300 can be correspond flexibility still in case of small of the external auditory meatus, because said joint tube of ear-mold-side 300 does not put into the ear mold 1.

This point, it is different from prior art that the tube 802 is putted into the silicon ear mold 801 such as shown in. FIG. 8 of the former example.

Said tube of ear-mold-side 300 can be joined with the ear mold 1 by proper set-angle. In the ear mold, if said set-angle (direction) of said joint tube of ear-mold-side 300 is not proper, said ear mold, said joint tube of ear-mold-side 300 and said joint tube of ear-hook-hearing-side 301 become float from the ear. Therefore, the opening occurs between their joint tube 300-301 and the ear mold. Furthermore, the hand and finger etc become hang on said opening, and said joint tube 300-301 become easily take off from the ear.

According to the present invention, the position-relation-ship of the hub can be controlled when making time of mold, and the direction (angle) of said joint tube of ear-mold-side 300 can be appropriated. Said joint tube of ear-mold-side 300 can be inconspicuous attachment to the ear and can be covered by hair.

The forming materials of the ear mold in the present invention can be preferably used the silicon material.

The silicon resin can be cited as an example of said silicon material. Said joint tube of ear-hook-hearing-aid in need of exchanging 301 can be formed by the tube of polyvinylchloride. Said joint tube 301 is necessary to regularly exchange, because said joint tube 301 become stiffen along with using. Said tube 301 can be exchanged easily, because said tube 301 joins with said joint tube of ear-mold-side 300 and said tube 301 independents from the ear mold 1.

The ear mold 1 has the sound-leading-hole as shown in FIGS. 1, 2 and 3.

This sound-leading-hole may be formed by picking of the ear impression of hardened plaster from flask (mold vessel), disposing of a wire having fixed-diameter, and molding by the silicon material of the forming material of the ear mold.

In the present invention, a bent-hole (an air-hole) can be arranged.

The present invention is not limited to the above-mentioned specific embodiments and various change and modifications may be made, for example, embodiment that the ear mold join with the body portion of the hearing aid by two tubes has shown in above-mentioned, but more than three tubes may be applied.

### INDUSTRIAL APPLICABILITY

The present invention may be applicable to mold by the other forming material except for the silicon forming material.

### BRIEF DESCRIPTION OF THE DRAWINGS

FIG. 1 is example of a schematic view of the ear mold embodying the present invention;

FIG. 2 is partial schematic view of the ear mold embodying the present invention;

FIG. 3 is partial sectional view of the ear mold embodying the present invention;

FIG. 4 is schematic view of the hub embodying the present invention;

FIG. 5 is schematic view of the hub the other embodying the present invention;

FIG. 6 is schematic view of the hub still more the other embodying the present invention.

FIG. 7 (PRIOR ART) is schematic view showing examples of conventional ear mold;

FIG. 8A (PRIOR ART) is schematic view showing examples of conventional ear mold.

FIG. 8B (PRIOR ART) is schematic view showing made of the metal bush (a bushing) for use in the above-mentioned ear mold as shown in FIG. 8A.

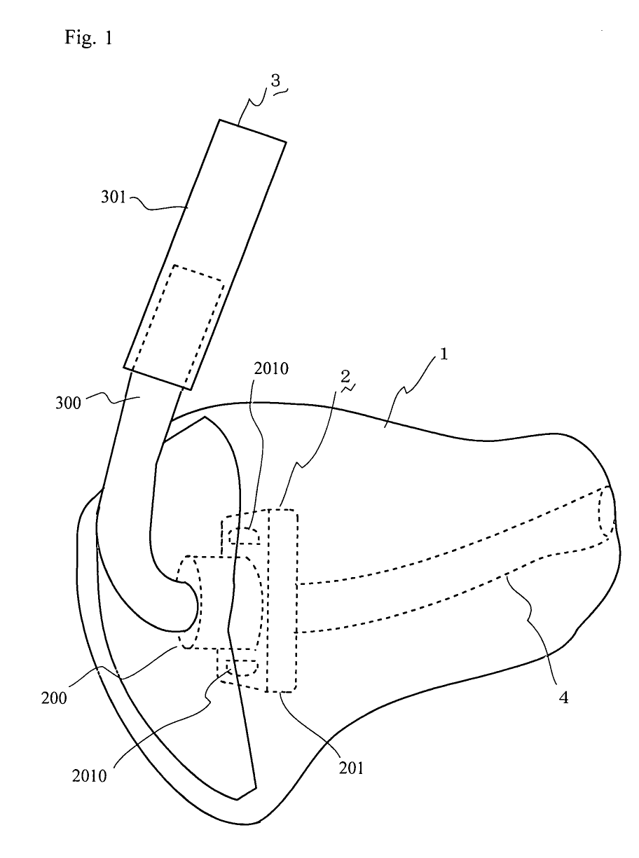

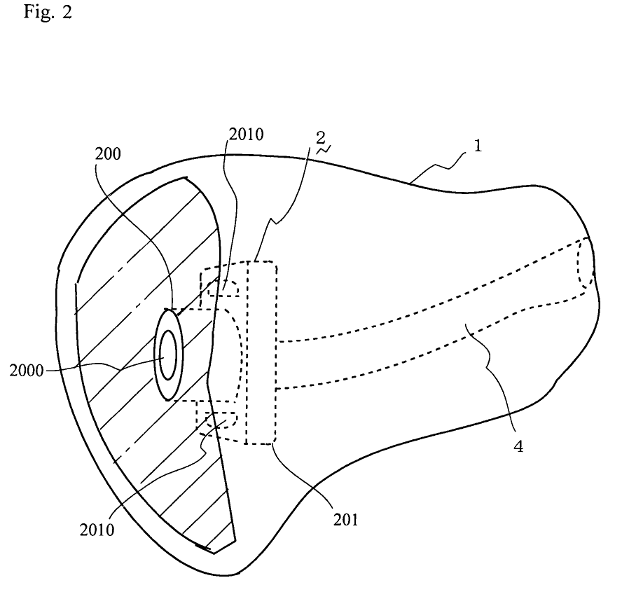

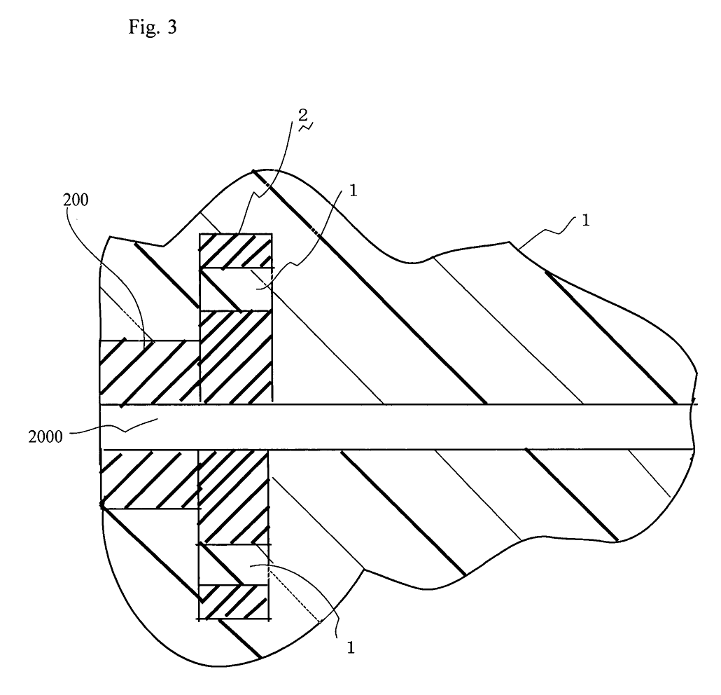

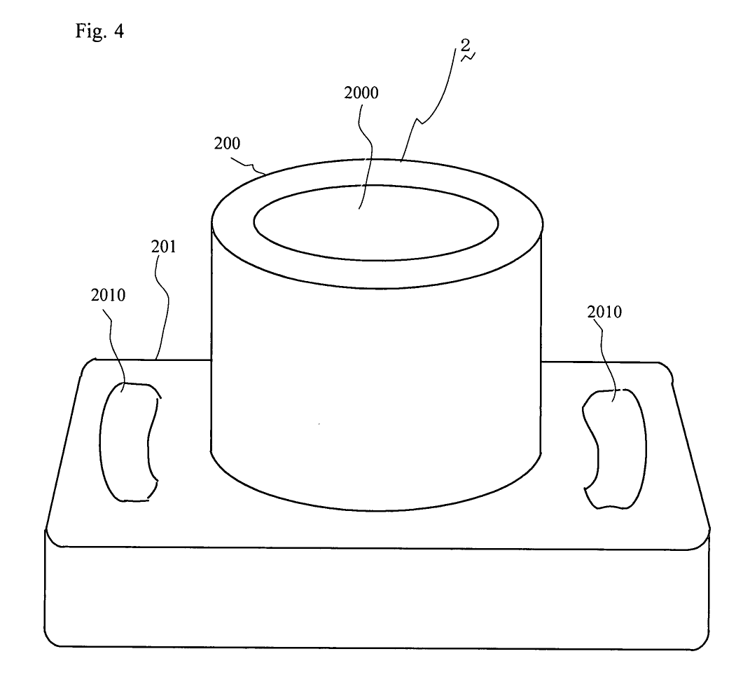

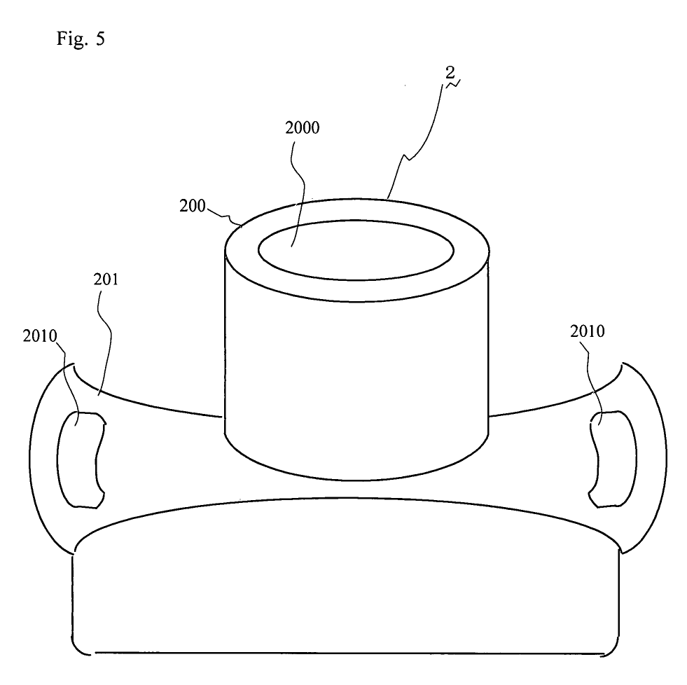

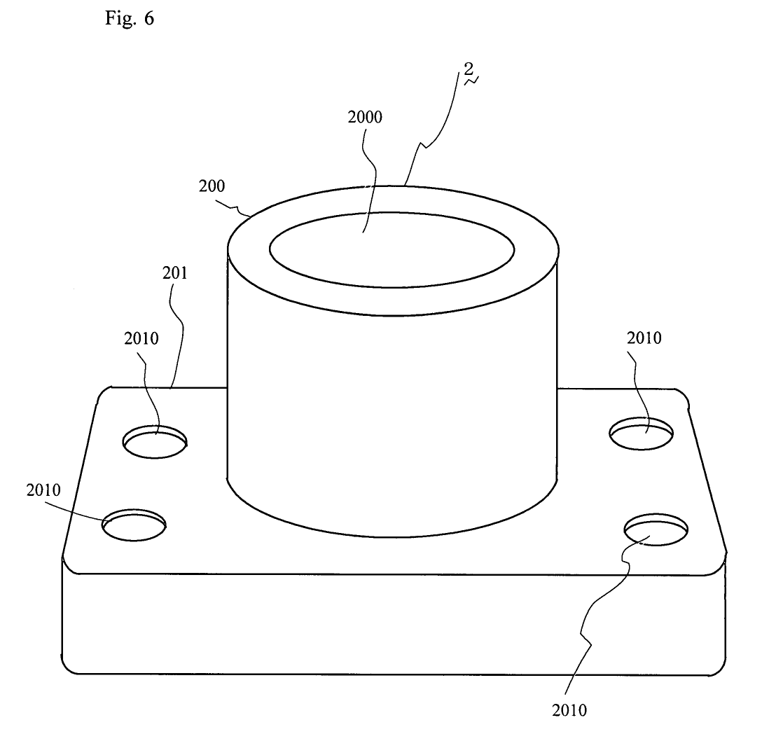

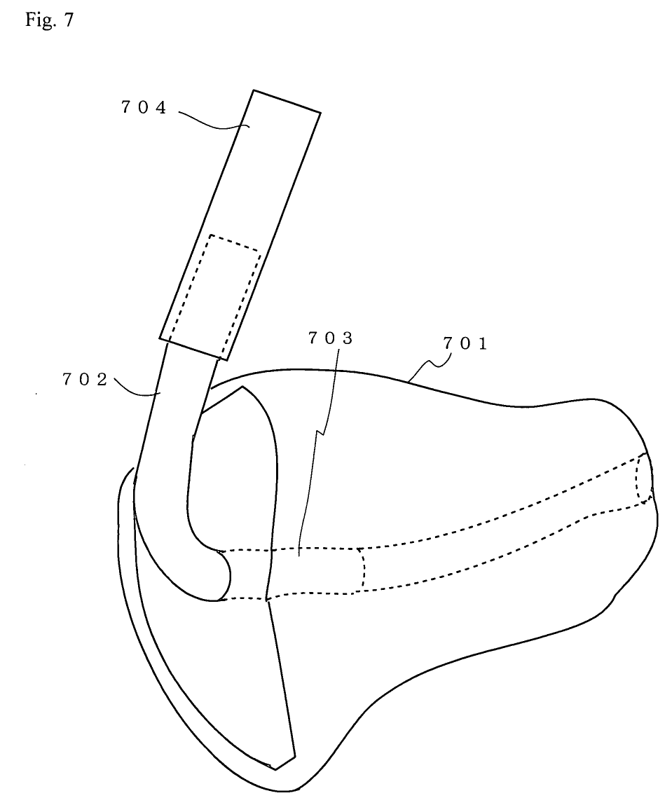

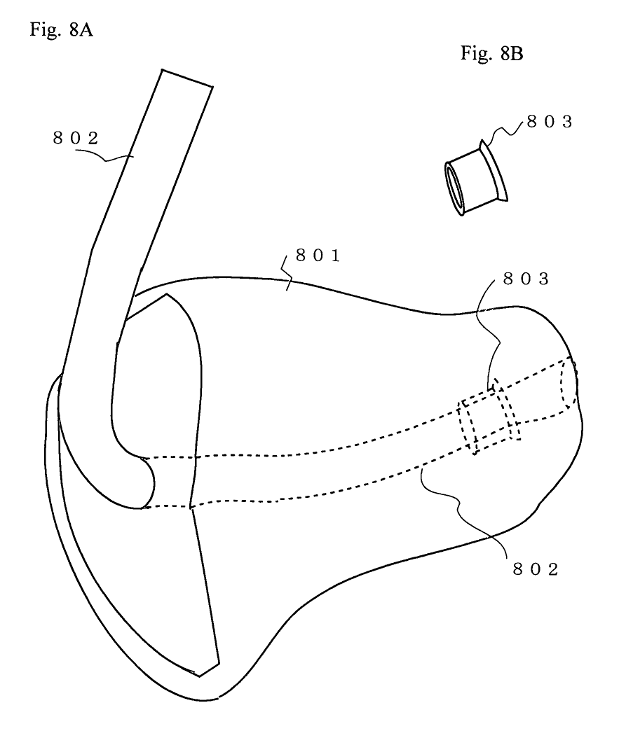

1 The ear mold
2 The connection and fixation member for a tube for connection to a hearing aid (the hub)
3 The tube for joint of the hearing aid
200 The joint portion
201 The body portion
2000 The joint-hole for the tube joint of ear-mold-side
2010 The introductory-hole for a forming material of the ear mold

1-6. (canceled)

7. An ear mold may be joined with an ear hook aid through the plural tubes and based on an ear-impression of custom-made, comprising:
said plural tubes comprises a tube for joint of the ear-hook-aid-side in need of exchanging and a tube for joint of the ear-mold-side which may be joined with the ear mold based on said ear-impression of custom-made, in said ear mold, a connection and fixation member having a joint-hole for joint of the ear-mold-side and introductory-hole of a forming material of said ear mold is embedded in said ear mold,
said connection and fixation member is contacted and fixed with said forming material through said introductory-hole,
said connection and fixation member join with said tube for joint of the ear-mold -side in the end portion of said ear mold,
said ear mold has a sound-leading-hole formed by the forming material of said ear mold.

8. An ear mold according to claim 7, wherein said tube for joint of the ear-mold-side comprises a plastics-elbow or nylon-L-tube.

9. An ear mold according to claim 7, wherein said forming material of the ear mold comprises a silicon resin.

10. A method of manufacture of the ear mold based on the ear-impression of custom-made in the ear hook aid comprising:
when manufacture of the ear mold which the forming material for the lug plug section inserts into the external auditory meatus of the user and hardening, after, the forming material of the ear mold poured into said produced plaster based on the ear-impression of custom-made and hardening of said forming material of the ear mold,
the process which the connection and fixation member having a joint-hole for joint of the ear-mold-side which may be joined with a tube for joint of the ear -hook-aid-side in need of exchanging and introductory-hole of a forming material of said ear mold embeds into said ear mold,
the process which said connection and fixation member contact and fix with said forming material through said introductory-hole by introduction of the forming material of the ear mold through the introductory-hole,
the process which said connection and fixation member join with said joint tube of the ear-mold-side in the end portion of said ear mold, and
the process of forming of a sound-leading-hole formed by the forming material of said ear mold.
